(19) United States
(12) Patent Application Publication
(10) Pub. No.: US 2005/0027582 A1
(43) Pub. Date: Feb. 3, 2005

(54) Project modelling and management tool

(76) Inventors: Pierre Chereau, Sion (CH); Jacques Chereau, London (GB); Francois Leduc, London (GB); Philippe Rideau, London (GB)

Correspondence Address: YOUNG & THOMPSON, 745 SOUTH 23RD STREET, 2ND FLOOR, ARLINGTON, VA, 22202, US

(21) Appl. No.: 10/487,095

(22) PCT Filed: Aug. 12, 2002
(86) PCT No.: PCT/EP02/09094

(30) Foreign Application Priority Data
Aug. 20, 2001 (LU) 90817

(51) Int. Cl. G06F 17/60

(52) U.S. Cl. 705/9

(57) ABSTRACT

The invention concerns a project management tool comprising a plurality of terminals communicating with a central server, at least one of the terminals including: means (11) for defining project models and for inserting them in a model library (6a), each project model including a list of step models, one step representing a set of tasks contributing to the achievement of the project; means (15) for defining a scenario defining links between a source model and a target model, each link being associated with a condition concerning the properties of the source model of the link; means (21) for generating projects from project models and steps from step models; and means (30) for updating and display the state of the project steps, and for generating a new step from the target model of a scenario link, when the condition associated with the link is fulfilled.

The present invention relates to a project management tool addressing not only the requirements for planning but also the requirement for monitoring and following up projects.

Traditionally, a project is broken down into tasks which are completed in view of achieving one goal, completing the project. The completion of these tasks requires the involvement of resources provided by an organisation such as a company carrying its activities in a specific business field. Resources include staff members of the organisation and equipments owned by that organisation.

Generally, one can distinguish between two types of activities: activities consisting of a few large projects and activities consisting of many small projects. Large projects involve a large number of resources dedicated to the projects during long periods of time. Small projects, often referred to as files, matters, cases or contracts, involve only a small number of resources that share their time between several projects at the same time.

Existing project management tools are designed to manage and plan large projects.

The breakdown into tasks of a large project is generally hierarchical, with tasks regrouping sub-tasks. Moreover, project tasks can be linked by constraints of the type predecessor/successor in order to introduce an order in which tasks have to be executed. Such an order is generally represented in the form of GANTT charts or PERT charts.

This approach raises a first series of issues.

Project management is a macroscopic activity which does not go into the details of planning each hour of work, whereas project follow-up and management of resource utilisation is a microscopic activity which takes into account every hour spent. As a consequence, either one privileges project management with a limited number of tasks, and in this case the granularity of tasks is insufficient for managing time spent, especially if the number of resources required to complete a task is high. Or one privileges the management of resource utilisation which implies far too many tasks for achieving serious planning with a traditional project management tool.

Furthermore, project management focuses on a project in its entirety and in particular on a project end date. Even if milestones are introduced in order to detect potential shifts, it is frequent that the delays that these milestones reveal are not significant due to tasks initially forgotten and subsequently added to the project or tasks executed in an order different from the order of the planned project. For that reason, it is frequent to break down large projects into smaller projects. However such a breakdown requires consolidating the smaller projects into the large project, which is a cumbersome, time consuming and error prone exercise.

In addition, existing project management tools are designed to manage one project at a time, which raises other issues when a single resource must be allocated to several projects. It becomes difficult to estimate the workload of a resource allocated to several projects. And these tools which rely on the critical path method are designed to calculate the project end date but are not adapted to calculate and monitor several intermediate due dates.

The traditional approach to project management raises a second series of issues. Generally, small projects are not planned because the workload to execute a small project cannot justify the workload to plan this project. The breakdown of a project into tasks allocated to resources is nevertheless necessary for monitoring and following up. Traditional project management tools do not permit the automatic generation of project data required to monitor and follow up large volumes of small projects, which would be too heavy or even impossible to produce manually. Moreover, some small projects last for years but only require small but often recurring interventions during the life cycle of the project. Traditional project management tools do not provide any automation to plan and follow-up the due dates of these recurring interventions.

The present invention aims at solving these issues. This goal is achieved through the design of a project management tool comprising a series of terminals communicating with a central server, characterised in that at least one of the terminals comprises:
means to define project templates and to store them in a template library, accessible through the central server, each project template comprising a list of stage templates, each stage of a project representing a set of collective works participating in the execution of the project and achieving an intermediate result, with a state associated with each stage;
means to define at least a scenario for a project template, which is stored in the template library in relation with the corresponding project template, each scenario defining succession links between two nodes respectively associated with two stage templates, that is one node at the origin of the link and one node at the destination of the link, each link being associated with a condition expressed as a function of properties of the stage template associated with the node at the origin of the link;
means to generate a project from a project template selected in the template library;
   each terminal comprising:
means to generate stages from stage templates; and
means of project follow-up allowing to update and visualize the state of project stages that have been previously generated by the means to generate stages, and of triggering the generation of a new stage according to a stage template associated with the node at the destination of a scenario link when a condition associated with that link is satisfied by the properties of a stage associated with the node at the origin of the link.

Advantageously, each stage template, part of the stage templates, comprises a list of task templates defining tasks necessary to the completion of a stage generated from this stage template, the project management tool comprising means to generate tasks from task templates and means for updating and following up tasks previously generated.

Preferably, the project management tool according to the invention, comprises means to define at least one scenario for a stage template, which is stored in the template library, in relation with the corresponding stage template, each scenario defining succession links between two nodes associated respectively to task templates, that is one node at the origin of the link and one node at the destination of the link, each link being associated with a condition expressed as a function of the properties of the task template associated with the node at the origin of the link.

According to a particularity of the invention, the project management tool comprises means to define sub-project templates of a project template or another sub-project template, and means to define scenarios comprising succession links between two templates among project templates and sub-project templates, that is one template at the origin of the link and one template at the destination of the link.

According to another particularity of the invention, the project management tool comprises means to define a terminal node in a scenario, which node is associated with an origin node in another scenario, and means to trigger a scenario whose origin node is associated with a terminal node of another scenario in progress, when a condition related to a template associated with the terminal node is validated.

According to another particularity of the invention, the project management tool comprises a stage template and this stage template comprises the definition of at least one planned date or one effective date, a stage according to such stage template including at least a corresponding planned date or effective date, each link of a scenario being associated with an interval and a date chosen among the planned dates and effective dates of a stage defined by its stage template and corresponding to an anchor node of the link.

Advantageously, the anchor node of a link is the origin node of this link.

In particular, the means to define a scenario comprise:
means to insert in a screen display panel a graphical symbol for a node representing a stage template,
means to insert in said panel a graphical symbol for a link between two node symbols, and representing a scenario link between two stage templates, and
means to insert in said panel a graphical symbol for a recursive link having for origin and destination a same node symbol, indicating that the stage represented by the node at the origin and destination of the link should be executed several times at regular intervals.

Preferably, the project management tool according to the invention comprises means to associate a data entry form to a template, which data is specific to the objects generated from this template, and means to convert a form defined by a user in a standard form description language into a form that can be used by the project management tool and associated with this template and to the objects generated from this template.

Advantageously, during the execution of a scenario, the project management tool comprises means to detect the change of a property of a stage associated with a scenario node, means to find the node associated with that stage and the outbound links of this node, means to obtain the condition associated with each outbound link found, means to validate each of these conditions, means to obtain the destination node of a link associated with a validated condition and the stage template associated with the destination node obtained, and means to create a stage from the stage template thus obtained.

A preferred execution mode of the project management tool according to the invention is described hereunder, as a non-limitative example, with references to the drawings enclosed, in which:

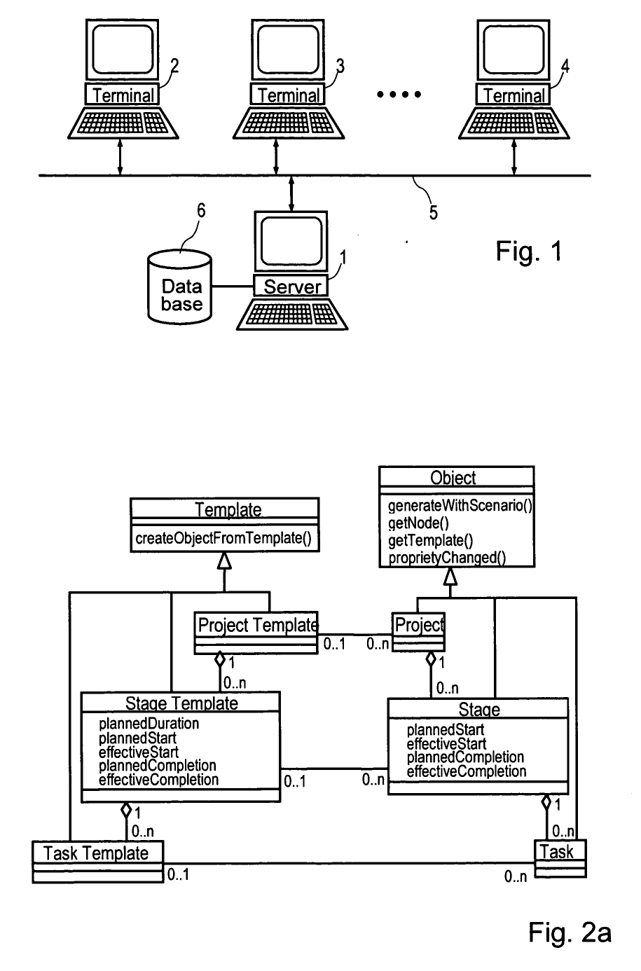

FIG. 1 is a schematic representation of a system which implements the project management tool according to the invention;

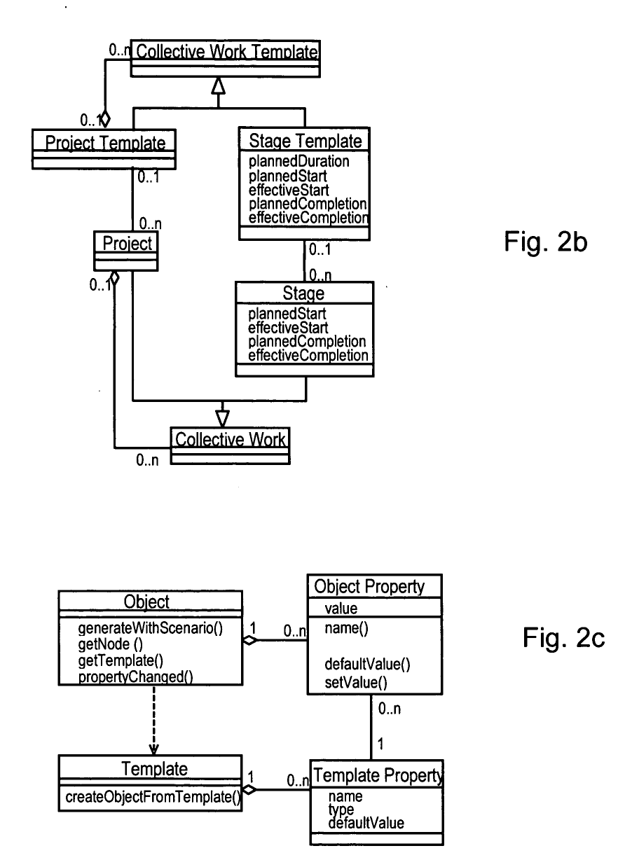

FIGS. 2a, 2b and 2c use the object oriented formalism of the UML methodology to describe the structure of templates and objects handled in the project management tool according to the invention;

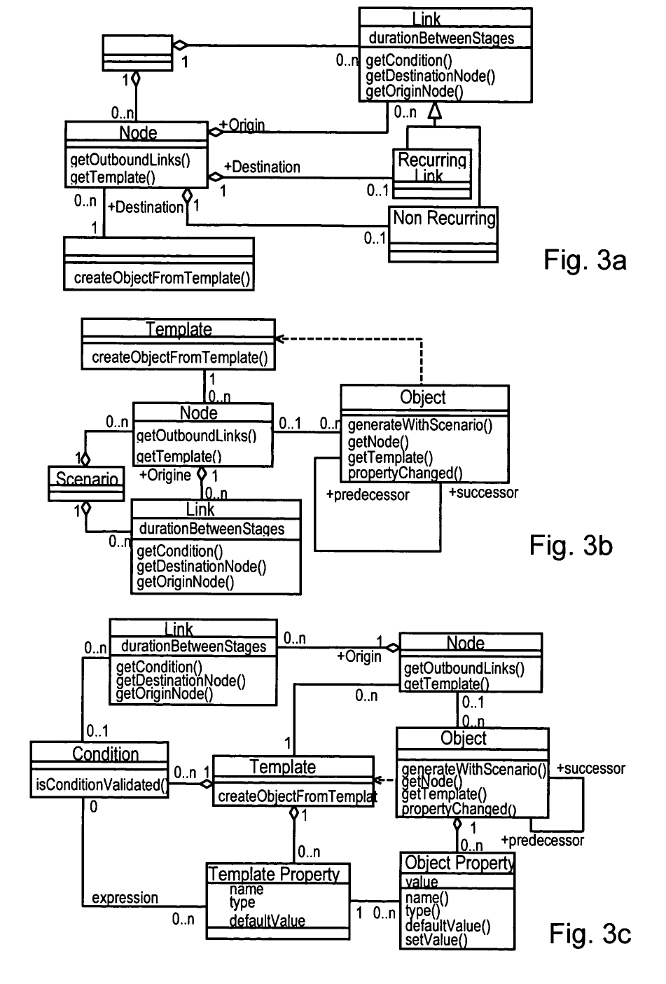

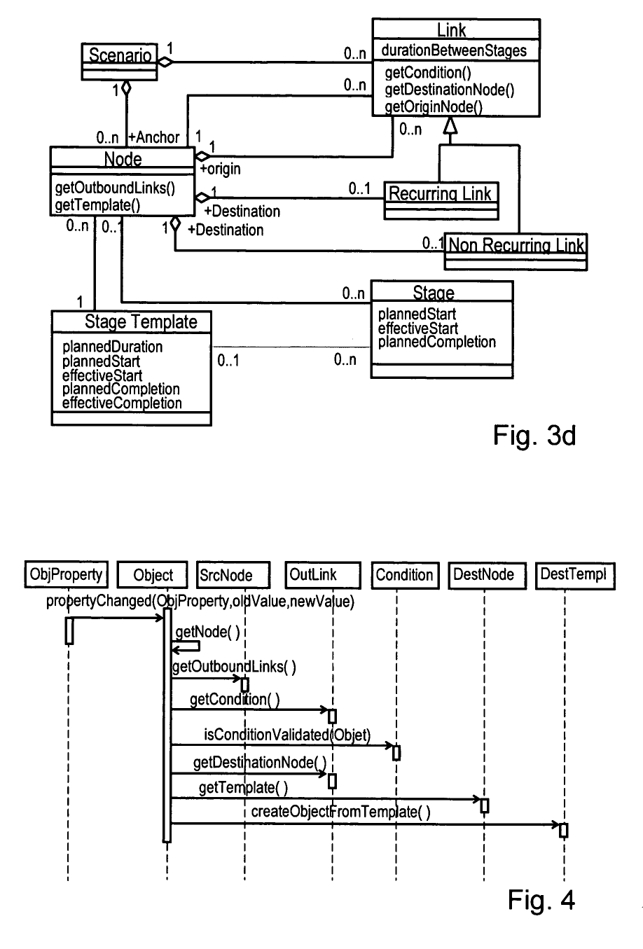

FIGS. 3a, 3b, 3c and 3d use the object oriented formalism of the UML methodology to describe the structure of a scenario and its functioning;

FIG. 4 illustrates in a sequence diagram according to the UML methodology, the mechanisms implemented in a scenario according to the invention;

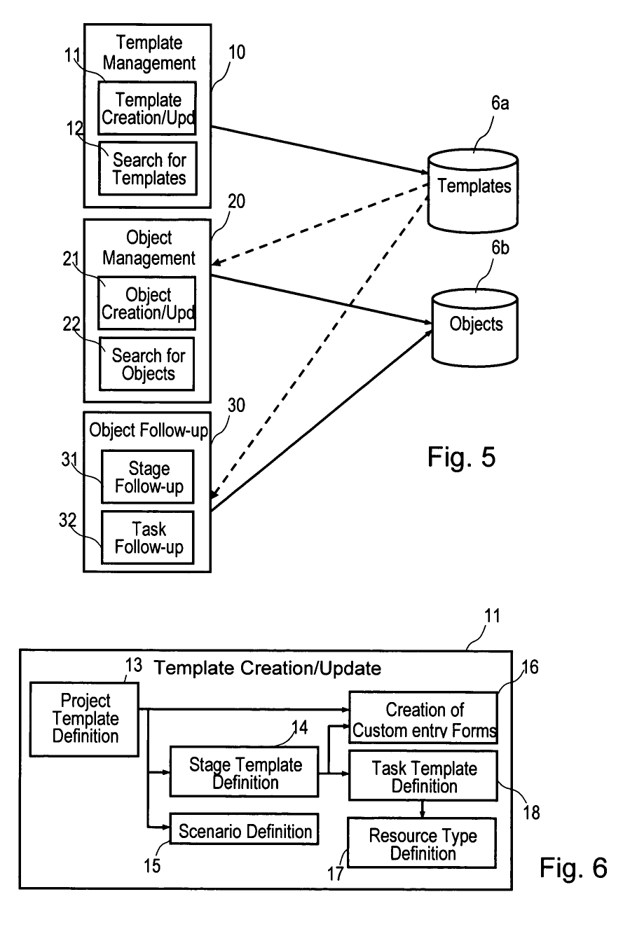

FIG. 5 shows the main modules of a project management tool according to the invention;

FIG. 6 shows the details of one of the main modules represented on FIG. 5;

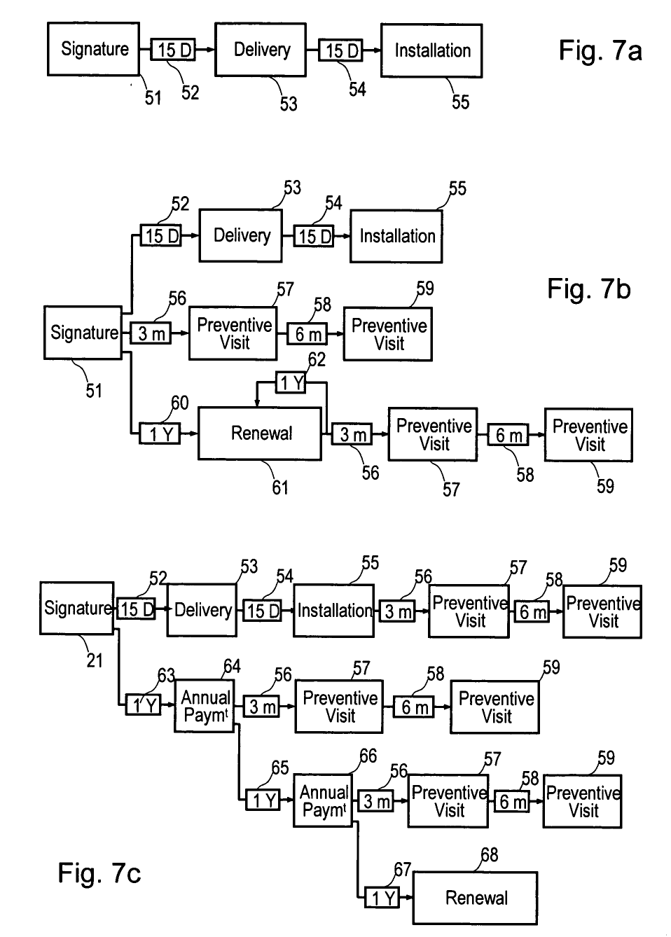

FIGS. 7a, 7b and 7c are examples of scenarios created and used by the project management tool according to the invention.

FIG. 1 represents a system which implements the project management tool according to the invention. This system comprises multiple terminals 2 to 4 at the disposal of users from one or more organisations and connected through a private network 5 and/or a public data network to one or more computing servers 1. Server 1 is also connected to a stocking unit 6 containing a database. In such a system, terminals 2 to 4 are generally constituted of desktop computers, but can also be constituted of mobile phones or even of pocket computers and personal data assistants. Moreover, server 1 is preferably a Web server. Obviously, network 5 can be constituted by one or more interconnected private and public data networks.

In this system, server 1 makes accessible to terminals 2 to 4 the various functions of the project management tool, along with the data generated and stored by the project management tool in the stocking unit 6. Obviously, access rights can be attributed to the various users of these terminals in view to prevent them to access certain functions or data depending on these access rights.

In addition to the traditional breakdown of a project into sub-projects then into tasks, the invention introduces an intermediate level of breakdown between projects and tasks, called “stages” which correspond to a commitment of a set of resources allocated to the project in view to deliver a certain result at a certain due date. For example, such a commitment corresponds to an order from a customer, a project phase, a deliverable or a billed service. One of the main properties of a stage is its milestone, which is the date when the stage objective is achieved or delivered. The effective date of the milestone is associated with a planned date called due date of the stage, which is the date before which the stage objective should be achieved or delivered, this date being eventually extended with grace periods that allow the stage to be completed without compromising the project.

In this breakdown, a task is conceived as the participation of one or more resources to this commitment. Project planning is then based on the breakdown into stages which hides the details of the list of tasks. As a consequence, a task can be added to a stage at any time without affecting directly the planning. Following a project consists of following the stages and tasks which is done by the resources assigned to the project. Thanks to the invention, the stages and the project are automatically updated by consolidating the data acquired at the task level.

Furthermore, the present invention is based on the statement that, in small projects activities, projects or matters can be categorised into a small number of groups of similar projects. The same applies to stages and tasks. Considering this statement, the invention introduces the notion of object template, an object being a project, a stage or a task, a template comprising all the common characteristics of objects in the same group of similar objects.

The common characteristics of a group of similar projects categorised in a project template comprise in particular scenarios that allow the reproduction of recurring behaviours in projects derived from these templates.

The project management tool according to the invention is implemented in two phases: a modelling phase for designing templates and a production phase for managing objects created from these templates.

Modelling templates consists on the one hand of identifying the different activities or project types in the organisation, and optionally arranging these project templates according to a hierarchical structure by identifying templates of “sub-projects”, and on the other hand of identifying the stage templates, task templates and resource types that are involved in the course of those projects managed by the organisation.

According to the invention, a project or sub-project template comprises:
an optional list of sub-project templates and rules for creating sub-projects according to these templates,
a list of properties for the project template, to be filled in forms that are specific to this template,
a list of stage templates and rules for creating stages according to these templates,
and possibly scenarios of sub-projects and stages for specifying a sequence of sub-projects and stages in the project template.

According to the invention, a stage template comprises:
a list of properties for the stage template, to be filled in forms that are specific to the stage template, including a set of states and planned intervals between two states,
an ordered or unordered list of task templates and rules for creating tasks according to these templates,
and possibly scenarios of tasks for specifying sequences of tasks in the stage template,

Because stages have variable execution durations and because it is not good practice to wait until the last minute to worry about their progress, the project management tool according to the invention provides the ability to monitor the state of a stage at any time and to send alerts when a stage is delayed or when a due date is passed. In this respect, stage templates provide the ability to predefine the development of a stage generated from a stage template, including the dates that have to be monitored from the creation of the stage until its completion. Each stage is associated with two series of dates:
planned dates which are defined and recorded at the creation of the stage, and
effective dates which are recorded during the course of the stage life.

If during the course of the stage life, an effective date is recorded after the corresponding planned date, the stage is deemed late.

The due date and the effective date of the stage milestone are apart in the planning and completion of a stage. Indeed, let us take the example of a “contract signature”. This stage comprises a certain number of tasks before (preparing the contract) and after (registering and invoicing the contract) the effective date of the signature. The effective date of the signature of a contract is the effective date of the milestone of the corresponding stage “contract signature”. The due date is the corresponding planned date.

On the due date, if the effective date of the stage milestone is not recorded or recorded with a subsequent date, the stage is deemed passed due.

As a non-limitative example, the dates and states presented in the table below are considered for stage monitoring and follow-up.

| Planned dates | Effective dates | State |
|---|---|---|
| Date planned for decision | Decision date | Decided |
| Date planned for start | Start date | Started |
| Date planned for completion | Completion date | Completed |

By default, a stage is created in project. In this state, the stage is waiting for a decision, which can take the form of a customer order, an internal decision or an external event. Then the stage is considered decided when its execution has been confirmed. The stage state evolves into started when the execution of the stage has begun. Finally, the stage gets into a completed state, unless it has been abandoned.

A stage template includes the definition of durations for calculating planned dates where the duration defines the period between a planned date and the due date of the stage milestone. As soon as the due date of a stage created from a template is defined, the planned dates are automatically calculated according to the durations defined in the template.

| Stage template | Stage | Calculation |
|---|---|---|
| Duration from | Planned date for | Due date - |
| decision to due date | decision = | Duration from |
| | | decision to due date |
| Duration from | Planned date for | Due date - |
| start to due date | start = | Duration from |
| | | start to due date |
| Duration from completion to | Planned date for | Due date - |
| due date | completion = | Duration from |
| | | completion to due date |

According to the invention, a task template comprises:
a planned workload and duration necessary to complete the task,
a list of resource types required to complete the task according to the template,
and possibly an ordering number.

In the following description, an “object” designates a project, a stage, a task or a resource and a “template” designates a project template, a stage template, a task template or a resource type.

FIG. 2a uses the object oriented formalism of the UML (Unified Modelling Language) methodology to describe the relations between the various types of templates and objects. This figure shows various blocks representing classes and divided in 3 boxes: a first box (starting at the top) with the name of the class, a second box with the list of attributes of the class and a third box with the list of methods of the class. The list of attributes contains various properties which define the state of an object derived from that class, whereas the methods are functions and procedures that the class can execute.

This figure comprises blocks marked “Template” and “Object” which identify two categories of blocks defined by the links represented with a triangle. Thus the block entitled “Template” is linked to blocks entitled “Project Template”, “Stage Template” and “Task Template” whereas the block entitled “Object” is linked to blocks entitled “Project”, “Stage” and “Task”. This representation simply indicates that the category “Template” groups project templates, stage templates and task templates, and that the category “Object” groups projects, stages and tasks.

Templates and objects as such are abstract. Only the projects and project templates, stages and stage templates, tasks and task templates have effectively persistent occurrences in the system.

Then the blocks entitled “Project Template”, “Stage Template” and “Task Template” are related with links which have a diamond at one end. This representation indicates that project templates aggregate stage templates which aggregate task templates. A task template is necessarily contained in a stage template and a stage template is necessarily contained in a project template. Blocks entitled “Project”, “Stage” and “Task” are related in the same way. This means that projects aggregate stages which aggregate tasks. A task is necessarily contained in a stage and a stage is necessarily contained in a project. The block entitled “Template” has among others a method called “createObjectFromTemplate” which permits to generate an object according to a template. The introduction of attributes and methods in a block that represents a category implicitly specifies that all the blocks derived from this category inherit these attributes and methods.

The block entitled “Object” has a method called “getTemplate” which enables each object to keep track of the template that has been used to create it and thus to retrieve it as and when needed.

Each link which has a diamond at one end is associated with numbers “1” and series of numbers “0 . . . n” respectively at the source block and destination block of the link. The diamond on the side of the source block of the link indicates that the source block aggregates the destination block, the life of which depends on the source block, for example the deletion of a project entails the deletion of the stages which depend on it. Numbers mean that the source block of the link contains between 0 and n occurrences of the destination block of the link, for example a project contains between 0 and n stages. At the opposite, the destination block of a link belongs to one and only one source block of that link, for example a stage belongs to one and only one project.

Moreover, the blocks entitled “Project Template”, “Stage Template” and “Task Template” are related by simple links to the blocks entitled respectively “Project”, “Stage” and “Task”. The ends of these simple links are associated with series of numbers “0 . . . 1” and “0 . . . n”. This means for example that a project template can be related to one or more projects. The absence of a diamond shape at the end of the link means that the destruction of one of the two blocks does not entail the destruction of the other block. In fact, these links correspond to the “getTemplate” method for each of the blocks entitled “Project”, “Stage” and “Task”.

The various planned dates and effective dates of a stage mentioned here above, can initially be considered as stage properties. To make things simple here, these dates are handled as attributes or properties of the stage object, providing these dates are shared among stages.

FIG. 2b uses the same UML formalism to describe another view of the relations existing between the various types of models and objects. This presentation reveals a hierarchical organisation of project templates and templates by introducing the abstract notions of collective work and collective work template which regroup respectively projects and stages on the one hand and project templates and stage templates on the other hand. Moreover, to model that a project can contain other projects, called sub-projects, projects aggregate collective works, which are projects or sub-projects and stages. Likewise, project templates aggregate collective work templates, which are project or sub-project templates and stage templates.

These hierarchies can be generalised on objects and templates, especially for a breakdown of tasks into elementary tasks and grouping tasks on the one hand and a breakdown of task templates into elementary task templates and grouping task templates on the other hand.

FIG. 2c details the design of templates and objects. A template defines a set of template properties with default values. A method called “createObjectFromTemplate” creates an object and copies for this object the whole set of template properties with their default values into object properties. Some template properties may eventually be transformed through the execution of the “createObjectFromTemplate” method, for example template properties expressed as durations can be computed into object properties expressed as dates. The values of object properties can then be modified independently from the default values of template properties.

According to the invention, the stages of a project can be linked together with one or more scenarios of successive stages, modelling the sequence of stages necessary to complete the project. In particular, scenarios permit to automatically generate the stages of the project depending on conditions which are functions of the properties and progress status of other stages in the project.

A scenario is an automaton which automatically creates objects from the templates specified in the scenario as and when they are necessary. A scenario is a set of nodes and links. The nodes represent the templates that have to be used to create the objects according to the scenario. Note that the same template can be referenced by several nodes of a same scenario. Such an automaton can apply to projects and sub-projects as well as to stages and tasks.

A scenario of stages is made of stage templates symbolised by nodes connected with links which represent a time span between a stage template at the origin and a stage template at the destination of the link. Each link designates accordingly:
a source node or origin of the link, associated to an origin stage template;
a destination node of the link, associated to a destination stage template;
a type of anchor date among the planned dates and effective dates of an origin stage: (planned) decision date, (planned) start date, (planned) completion date, due date and effective date of the stage milestone;
a duration expressed in days, months and years between the anchor date of the source of the link and the due date of the stage associated to the destination node of the link;
and possibly, a condition expressed as a function of the stage template properties. This condition can be advantageously implemented as a script interpreted by the system.

In the case where the origin and destination nodes of a link are identical, the link is said to be recurring. When these nodes are different, the link is not recurring.

FIG. 3a details the specification of scenarios. In this figure, the “link” block is abstract. In other words, only recurring links and non-recurring links actually have occurrences persisting in the system. A scenario comprises an origin node which is the only node which is not a destination for any link.

Note that the diagram of FIG. 3a can easily be modified to allow chaining scenarios, for example by introducing a sub-class called “terminal node” of the class “node” and thus specify a node which would not be the origin of any link in the scenario, but would be associated to the origin node of another scenario.

FIG. 3b describes the links between scenarios and objects. Objects, and in particular projects, stages and tasks, are not necessarily automatically created b scenarios. They can be created manually on an ad hoc basis according to the templates. In the case where an object has been generated with a scenario, this object keeps a reference to the node, and to the scenario which has permitted its creation. This reference is used to determine the next object to generate according to the links. It is obtained by using the “getNode” method on the object.

By extension, one calls scenario node template the template associated with said node, which is returned as a result of executing the “getTemplate” method on the node. One calls origin template, respectively destination template, the template associated with the node at the origin of a scenario link, respectively at the destination of a scenario link. One calls origin object, respectively destination object, an object generated with a scenario according to an origin template, respectively a destination template.

Classes derived from class “Object” which use scenario for automatic generation, in particular project, stage and task, implement the “generateWithScenario” method (see also FIGS. 2a and 2c). When calling this method, an object created from a scenario node obtains the said node by calling the “getNode” method. This node is at the origin of the link considered for generation. The “getOutboundLinks” method of the origin node returns a collection of outbound links. The “getDestinationNode” method called on each outbound link enables getting a collection of destination nodes of the links. The “getTemplate” method called on each destination node of every link returns a collection of corresponding templates, in order to create eventually the corresponding destination objects by calling the “createObjectFromTemplate” method on every template.

It is possible to control the existence of a destination object before generating it according to a destination template defined on a link, in order not to duplicate the same generation. For this purpose, each object keeps a reference of its successors. Each time the generation of a destination object is triggered following a link, the existence of a successive object which would reference the destination node of that link has to be checked in order to avoid repeating a generation which has already occurred.

FIG. 3c describes the implementation of a condition for generating a destination object following a scenario link. An origin template contains a set of predefined conditions for generating destination objects following a scenario link. A link connected to a node referencing this origin template may designate a condition of this set for generating a destination object following this link. The condition is checked using the “isConditionValidated” method, which is an expression of the properties of a same template and which returns a Boolean. This method takes the origin object as a parameter and uses the values of the properties of this origin object which correspond to the template properties designated in the expression for validating the condition. The destination object is created according to the scenario only if the condition is validated.

As an example, we consider a scenario comprising at least two nodes and a link. The first stage template corresponding to the first node, at the origin of the link, is a “contract signature” and the second stage template corresponding to the second node, at the destination of the link, is a “credit check”. The stage template called “contract signature” comprises a template property of type currency and named “amount”. The condition associated to the link is “amount above 10,000.00” which means that the credit check is only performed if the amount is above 10,000.00. Stage “signature of Mr. Bloggs' contract” is a specific instance of the stage template “contract signature”. If the object property corresponding to “amount” has a value of 18,000.00, the condition is validated and the stage of credit check for Mr. Bloggs is generated for its execution.

At this level, generating the object following the link is triggered by an action in the user interface. Preferably, this generation is triggered by a system event, for example when object property “amount” is valued.

For that purpose, a notification mechanism can be considered and used to build an event model. Modifying an object property value by using the “setValue” method systematically triggers an event notification raised by the object from which depends the object property, by a call to the “propertychanged” method of that object.

FIG. 4 shows a sequence diagram according to the UML methodology of a generation following a scenario with such a condition and events. Each time a new value is assigned to an object property, the object is notified by a call to its “propertyChanged” method. The object uses its “getNode” method to find the scenario and node which have permitted its creation. If such a node does not exist, the object is not part of the execution of a scenario and the sequence does not apply. If such a node exists, the object calls the “getOutboundLinks” method of this node to obtain a collection of links that originate from this node. For each of the outbound links, a call to the “getcondition” method returns the condition which applies and which is validated through a call to the “isConditionValidated” method. If the condition is not validated, the sequence evaluates the next link in the collection. If the condition is validated, the object obtains the destination node of the link by calling the “getDestinationNode” method of the outbound link, and the associated template by calling the “getTemplate” method of the destination node. Finally, a call to the “createObjectFromTemplate” method of the destination template permits the creation of the destination object. The sequence moves to the next link in the collection of outbound links until it reaches the last element of the collection.

FIG. 3d describes a specific application of scenarios according to the invention. The scenario automatically generates stages and positions them over time. To do so, every stage comprises the following object properties: “plannedStart”, “effectiveStart”, “plannedCompletion”, “effectiveCompletion” (see also FIGS. 2a and 2b) from which the following states can be deduced:
“In project” or “Not started” if both the effective start date and the effective completion date have not been provided,
“Started” or “Not completed” if the effective start date has been provided, but not the effective completion date,
“Completed” if the effective completion date has been provided.

The scenario is used to compute the planned completion date (“plannedCompletion”) of a destination stage (“destinationStage”) of a link using a function of the interval (“intervalBetweenStages”) between the origin stage (“originStage”) and destination stage of the link. The stage template (“destinationStageTemplate”) provides the ability to deduce the planned start date (“plannedStart”) from the planned duration (“plannedDuration”) of the destination stage template. In a first variant, the following assertions are made:
destinationStage.plannedCompletion=originStage.effectiveCompletion+link. intervalBetweenStages
and
destinationStage.plannedStart=destinationStage.plannedCompletion−destinationStageTemplate.plannedDuration

In a second variant, the link designates an anchor node for calculation purpose. One calls anchor stage template the stage template designated by the anchor node of a scenario link and anchor stage (“anchorStage”) the corresponding stage. Calculation becomes:
destinationStage.plannedCompletion=anchorStage.effectiveCompletion+link. intervalBetweenStages
and
destinationStage.plannedStart=destinationStage.plannedCompletion−destinationStageTemplate.plannedDuration

Note that the first variant is a specific occurrence of the second variant where origin node and anchor node are identical.

In a third variant, the condition which applies to the link is “anchorStage.effectiveCompletion is valued (not null)”. By extension, the generation of the destination stage is executed after notification of the change of value of the “effectiveCompletion” object property when it is provided.

In a fourth variant, the date of the anchor stage on which the calculation is based, is specified in the link with a “chosendate” which can reference any of the object properties including “plannedStart”, “effectiveStart”, “plannedCompletion” or “effectiveCompletion” and the calculations become:
destinationStage.plannedCompletion=anchorStage.chosenDate+link. intervalBetweenStages
and
destinationStage.plannedStart=destinationStage.plannedCompletion−destinationStageTemplate.plannedDuration

It is possible to consider a whole series of dates as object properties of a stage including order date, planning date and invoice date.

For the implementation of all the mechanisms that have been described hereinabove, the project management tool according to the invention comprises three main modules (see FIG. 5): a module for managing templates 10, a module for managing objects 20 and a module for following up and monitoring objects 30.

The module for managing templates 10 comprises a module for creating and updating templates 11, in particular project templates, stage templates, task templates and resource types, which are arranged in a template library 6 a stored in a stocking unit 6, and a module 12 for searching for these templates. The module for managing objects 20 comprises a module 21 for creating and updating objects, in particular projects, stages, tasks and resources, in compliance with the templates stored in the library 6a, these objects being arranged in a database 6b also stored in the stocking unit 6, and a module 22 for searching for these objects.

The module for monitoring and following up objects 30 is designed for listing objects according to criteria to be entered, in particular the state of these objects at a certain date. This module comprises a module for monitoring and following up stages 31, designed for listing stages, and a module for monitoring and following up tasks 32, designed for listing tasks, and in particular for a given resource and a given period of time. The module for following up tasks can take the form of an electronic timesheet or an electronic personal diary.

As shown in details on FIG. 6, the module for creating and updating templates 11 comprises a function 13 for defining project templates, a function 16 for creating custom entry forms, a function 14 for defining stage templates, a function 15 for defining scenarios, a function 18 for defining tasks templates, and a function 17 for defining resource types.

The function for defining project templates 13 permits the entry of general information related to the project template like a title and a description. This function implements sub-project templates to allow the break-down of a project template into several sub-project templates. For this purpose, the function for defining project templates permits specifying whether the new project template to create is a “root” project template of the hierarchy or a sub-project template which needs to be related to an existing project template called, parent project template. If the new project template to create is a sub-project template, function 13 permits specifying whether the corresponding sub-project should be created automatically with the parent project corresponding to the parent project template. Function 13 also permits defining a minimum and a maximum of occurrences of sub-projects within a parent project.

The function for creating custom forms 16 provides the ability to upload into the template library 6a one or more new forms defined in a standard language like HTML, to select an uploaded form and to assign it to a template. Advantageously, one can rely on any specific editor compatible with this language to create a form that can benefit the project management tool according to the invention. Function 16 also permits parsing the fields in the HTML form, and creating in the template library 6a the template properties for the template that uses the form.

These template properties are stored as a database table in the template library 6a as described below:

| Field | Type | Size | Description |
|---|---|---|---|
| Id | Long Int | N/A | Property Identifier |
| TemplateId | Long Int | N/A | Template Identifier |
| Or ObjectId | | | |
| Name | Varchar | 50 | Property Name |
| Datatype | Varchar | 20 | Property Type: Number, |
| | | | Text, Date, Boolean, etc. |
| Value | Varchar | 7000 | Value |

Possibly, specific attributes can be added to the HTML tags to validate the type of entries in text boxes. In HTML a textbox is defined by the following tag:
<input type=“text” name=“T1” size=”20”>
which can be enriched with the data-type attribute for type validation, in the following manner:
<input type=“text” name=“T1” size=“20” data-type=“date”>
in order to control effectively the type of data entries allowed in the textbox. Other attributes can be considered on the same principle, especially for validating the domain of data entries.

Function 16 also permits interpreting a form and displaying it with the corresponding data read from the above mentioned database table. The document object model of a browser gives the ability to read and write data in the form fields of an HTML page as rendered by the browser.

Function 14 permits defining the stage templates that belong to a project template. In particular, this function permits the entry of general information related to the stage template like a title and a description. This function calls function 16 to assign one or more custom forms for data entries related to a stage according to this template. It is also designed for defining the planned durations of a stage template, and eventually for specifying a list of tasks that have to be completed to execute the stage by calling the function 18 of task template definition.

Function 18 allows to breakdown a stage template into a list of task templates and for each task template added to the list, to specify a name, a description, a planned workload and planned duration necessary for completing the corresponding task. To allocate one or more types of resources to a task template, function 18 calls function 17.

Apart from assigning resource types to task templates, function 17 allows the constitution of a catalogue of resource types available in the system for executing projects. Resource types correspond to the roles that can be played by a resource in a project, for example project manager, engineer, consultant, technician or assistant.

Function 15 for scenario definition permits specifying a name, a description and optionally a period of validity of the scenario, and also to draw a graphical representation of the scenario in a drawing panel, with nodes and links between nodes. The addition of a new node opens a window for selecting a stage template among the list of stage templates relevant to the current project template, and the addition of a new link between two nodes requires the entry of an anchor date, an interval from the anchor date and a condition to execute the link. This function also allows the addition of recurring links that are links where the origin node and the destination node are identical.

FIGS. 7a, 7b and 7c show examples of scenarios.

FIG. 7a illustrates a scenario for selling appliances without maintenance. This scenario comprises a first stage represented by an origin node 51 of the scenario, corresponding to the signature of the sale agreement by a customer, a stage represented by a second node 53, corresponding to the delivery of the appliance, and a stage represented by a third node 55, corresponding to the installation of the appliance. The first and second nodes are connected by a link associated with an interval 52, which indicates that the delivery of the appliance to the customer should be completed within 16 days from contract signature. The second and third nodes are also connected by a link associated with a duration 54, which indicates that the installation of the appliance should be completed within 16 days from its delivery. Both links 52 and 54 have an anchor date which is not represented. This anchor date is the completion date of the stage corresponding to the node at the origin of the link, because it is not possible to deliver without signature and to install without delivery. FIG. 7b illustrates a scenario for selling appliances with maintenance, where the agreement is renewable annually and provides for two annual preventive visits. In addition to stages 51, 53, 55 and links 52, 54 of the scenario for selling appliances without maintenance, as shown on FIG. 7a, this scenario comprises a first stage 57 of preventive maintenance visit, triggered 3 months after contract signature (link 56) and a second stage 59 of preventive visit triggered 6 months (link 58) after the first stage of preventive visit 57. For both links 56 and 58, the anchor date which is not represented, is the due date of the stage at the origin of the link, because even if the first visit 57 is delayed or cancelled, the second visit has to occur according to the signed contract terms.

According to a variant of execution of the invention described above as scenario chains, there is a benefit in regrouping the successive preventive visits in an independent scenario and to chain the signature 51 and the renewal 61 to this independent scenario. Likewise, there is no need to duplicate the structure made of nodes 57 and 59 connected by link 58.

Because the maintenance agreement is renewable every year, the corresponding scenario comprises a stage 61 of renewal, connected to the stage 51 of signature by a link 60 with a period of one year, and the stage of renewal is connected to itself by a recurring link 62 also with a period of one year. Stage 61 is also connected (link 56) to a first stage 57 of preventive visit, which is connected (link 58) to a second preventive visit 59. The anchor date for link 60 is the date of milestone completion (signature date) and the anchor date for link 62 is the renewal due date, in order to ensure a due date which always corresponds to the anniversary of the signature date.

FIG. 7c illustrates a scenario for renting appliances, where the contract has a duration of three years, including two annual preventive maintenance visits. This scenario also comprises an origin node 51 corresponding to contract signature and nodes 53 and 55 representing respectively the stages of delivery and installation, these three nodes being connected by links 52 and 54. Moreover, stage 55 of installation is connected by a link 56 with an interval of 3 months to a first stage of preventive visit 57, which is connected by a link 58 with an interval of 6 months to a second stage of preventive visit 59. The payment of the annual balance of rents by customer (stage 64), a year after the signature stage 51 (link 63), is followed 3 months later (link 56), by two stages of preventive visit 56 and 57, separated by a time interval of 6 months (link 58). These stages are repeated during the third year of the contract (link 65 between stages 64 and 66).

Because the contract can be renewed, the stage for annual payment 66 is connected by a link 67 with an interval of one year to a stage of renewal 68. The anchor dates can be deduced from the preceding explanations and are not detailed.

It is interesting to note that the “sale/rental of appliances” project template which comprises the three scenarios represented on FIGS. 7a, 7b and 7c, and the stage templates involved in these scenarios, also comprises a supplementary stage template for handling curative visits, which does not participate in any scenario. Curative visits are triggered at any time by customers when their apparel is faulty.

Function 15 for defining scenarios also permits to copy, paste and modify an existing scenario in order to create a new one. Likewise, functions 13 and 14 for defining project and stage templates permit to copy, paste and modify an existing project or stage template to create a new one.

Module 21 for creating and updating objects is designed for presenting to a user a list of all the project templates available in the template library 6a, these templates being advantageously grouped by business field to make selection easier.

Following user selection of a project template, this module creates a new project object in the database of objects 6b and displays a window on a user's terminal screen, comprising a panel for entering general information and panels for the custom forms corresponding to the selected project template.

Once a project has been created according to a template, the following phase consists in initiating a scenario. In this respect, module 21 for creating and updating objects gives access to the list of stage templates and scenarios of the project template used to create the project. It is possible to create a first stage from a stage template of the list. It is also possible to designate a scenario in the list and let it create the first stage from the template corresponding to its origin node.

In both cases, it is mandatory to enter the due date of the stage to create.

Module 21 creates a new stage object in the database of objects 6b and displays a window on a user's terminal screen, comprising a panel for entering general information, planned dates calculated from durations defined in the stage template, effective dates to be entered, and panels for the custom forms corresponding to the selected stage template.

Optionally, the list of tasks of a stage is generated according to the list of task templates included in the corresponding stage template. Preferably, this generation is executed from a user command or automatically when a stage passes a predefined state. For example, it is useless to break down an annual renewal into tasks a year before it is due.

Module 31 for following up stages returns a list of stages due within a period and which have reached a certain state at a certain date, for example due in the next 6 months and not yet decided. As in module 22 for searching and updating objects, module 31 for following stages permits to record effective dates and state changes of stages.

A user can resort to module 22 for searching and updating objects or module 31 for allocating resources to each task of a stage. For this purpose, the user has to select, for each task of the task list of a stage, the name of one or more resources, generally among the staff members of the organisation which hosts the system, within the list of resources of the database of objects 6b, corresponding to the resource types assigned to the tasks templates of the stage template.

A resource can use module 32 for following tasks, in view to record the progress of its work. The module for following tasks lists all the tasks allocated to this resource and which depend from stages which have been decided but not yet completed at a certain date. Advantageously, the module 32 for following tasks displays a timesheet, that is a table with tasks from the list as rows and days within a relevant period as columns, where the period can be the current week or the current month. Table cells at the intersection of rows and columns contain fields for entering time spans expressed in hours and minutes corresponding to the time spent by a resource to execute partially or fully the task in the corresponding day. Time spans are only durations, and the sum of them for all the resources of a same task constitutes the workload necessary to complete that task. The task duration is determined by the period that starts with the first time span and end with the last time span spent by any resource on the said task.

Module 20 for managing objects and module 30 for following objects provide the ability to mark tasks complete. Stage states are advantageously calculated from task states:
A stage is started when at least one of its tasks is started and the starting date of a stage is the date of the first time span worked by a resource on any task of that stage;
A stage is completed when all its tasks are completed and the completion date of that stage is the date of the latest time span worked by a resource on any task of that stage;

Any data entered by a user or computed following the project templates, stage templates and task templates are inserted by modules 20 and 30 into the database of objects 6b, in “stage” and “task” objects in relation to the corresponding “project” object.

Module 20 for managing objects permits the modification of calculated start dates and completion dates of stages, especially to take into account non recorded works.

Changes in stage states, determined by changes in their property values, trigger a call to module 21 for creating and updating objects, in order to progress the scenario previously initiated on the project. If the scenario identifies an outbound link for the current stage and if the current stage comprises the required data for creating the destination object of that link, the said destination object is generated with a due date which is function of the anchor date and of the interval, defined by the link, between said anchor date in the origin stage and the due date of the destination stage.

Depending on the number of outbound links, the corresponding destination stages are generated in the database of objects 6b. Each new destination stage is listed in the follow-up of stages and the process described here above is reproduced for the new stage. In the example represented on FIG. 7b, the completion of the “signature” stage triggers the generation of the “Delivery”, “Preventive Visit” and “Renewal” stages according to the corresponding stage templates.

And so on until the very last stage of a scenario. When this very last stage is completed, the project is eventually considered as completed.

Module 10 for modelling projects may only be accessible from a limited number of terminals 2 to 4, and more particularly only accessible to key employees of the organisation, whereas module 20 for managing objects and module 30 for monitoring and following up objects are accessible from every terminal, to let any resource of the organisation report on their work and insert into the database of objects 6b data related to projects, stages and tasks that they are executing.

Advantageously, the system comprises means to print details and lists of objects and templates.

1. Project management tool comprising a series of terminals (2, 3, 4) communicating with a central server (1), characterised in that at least one of the terminals comprises:
means (11) to define project templates and to store them in a template library (6a), accessible through the central server (1), each project template comprising a list of stage templates, each stage of a project representing a set of collective works participating in the execution of the project and achieving an intermediate result, with a state associated with each stage;
means (15) to define at least a scenario for a project template, which is stored in the template library (6a) in relation with the corresponding project template, each scenario defining succession links (52, 54) between two nodes (51, 53) respectively associated with two stage templates, that is one node (51) at the origin of the link and one node (53) at the destination of the link, each link being associated with a condition expressed as a function of properties of the stage template associated with the node at the origin of the link;
means (21) to generate a project from a project template selected in the template library;
each terminal comprising:
means (21) to generate stages from stage templates; and
means (30) of project follow-up allowing to update and visualize the state of project stages that have been previously generated by the means to generate stages, and of triggering the generation of a new stage according to a stage template associated with the node at the destination of a scenario link when a condition associated with that link is satisfied by the properties of a stage associated with the node at the origin of the link.

2. Project management tool according to claim 1, characterised in that each stage template, from at least a part of the stage templates, comprises a list of task templates defining tasks necessary to the completion of a stage generated from this stage template, the project management tool comprising means (21) to generate tasks from task templates and means (32) for updating and following up tasks previously generated.

3. Project management tool according to claim 2, characterised in that it comprises means (15) to define at least one scenario for a stage template, which is stored in the template library in relation with the corresponding stage template, each scenario defining succession links between two nodes respectively associated to task templates, that is one node at the origin of the link and one node at the destination of the link, each link being associated with a condition expressed as a function of the properties of the task template associated with the node at the origin of the link.

4. Project management tool according to claim 1, characterised in that it comprises means (11) to define sub-project templates of a project template or another sub-project template, and means (15) to define scenarios comprising succession links between two templates among project templates and sub-project templates, that is one template at the origin of the link and one template at the destination of the link.

5. Project management tool according to claim 1, characterised in that it comprises means to define a terminal node in a scenario, which node is associated with an origin node in another scenario, and means to trigger a scenario whose origin node is associated with a terminal node of another scenario in progress, when a condition related to a template associated with the terminal node is validated.

6. Project management tool according to claim 1, characterised in that it comprises a stage template and this stage template comprises the definition of at least one planned date or one effective date, a stage according to such stage template including at least a corresponding planned date or effective date, each link of a scenario being associated with an interval and a date chosen among the planned dates and effective dates of a stage defined by its stage template and corresponding to an anchor node of the link.

7. Project management tool according to claim 6, characterised in that the anchor node of a link is the origin node of this link.

8. Project management tool according to claim 1, characterised in that the means to define a scenario comprise:
means to insert in a screen display panel a graphical symbol for a node representing a stage template,
means to insert in said panel a graphical symbol for a link between two node symbols, and representing a scenario link between two stage templates, and
means to insert in said panel a graphical symbol for a recursive link having for origin and destination a same node symbol, indicating that the stage represented by the node at the origin and destination of the link should be executed several times at regular intervals.

9. Project management tool according to claim 1, characterised in that it comprises means (16) to associate a data entry form to a template, which data is specific to the object generated from this template, and means to convert a form defined by a user in a standard form description language into a form that can be used by the project management tool and associated with this template and to the objects generated from this template.

10. Project management tool according to claim 1, characterised in that during the execution of a scenario, the project management tool comprises means to detect the change of a property of a stage associated with a scenario node, means to find the node associated with that stage and the outbound links of this node, means to obtain the condition associated with each outbound link found, means to validate each of these conditions, means to obtain the destination node of a link associated with a validated condition and the stage template associated with the destination node obtained, and means to create a stage from the stage template thus obtained.
